(19) United States
(12) Patent Application Publication
(10) Pub. No.: US 2008/0115104 A1
(43) Pub. Date: May 15, 2008

(54) SOFTWARE DEVELOPMENT SYSTEM AND METHOD FOR INTELLIGENT DOCUMENT OUTPUT BASED ON USER-DEFINED RULES

(75) Inventor: KimJohn Quinn, Bloomfield Hills, MI (US)

Correspondence Address: HARNESS, DICKEY & PIERCE, P.L.C., P.O. BOX 828, BLOOMFIELD HILLS, MI, 48303, US

(73) Assignee: AjlSoft, Inc., Rochester, MI (US)

(21) Appl. No.: 11/938,602

(22) Filed: Nov. 12, 2007

Related U.S. Application Data
(60) Provisional application No. 60/858,903, filed on Nov. 14, 2006.

(51) Int. Cl. G06F 9/44

(52) U.S. Cl. 717/101

(57) ABSTRACT

A document development system is provided. The document development system includes a computer readable medium. The computer readable medium bears a project manager, a rules engine, and a user interface manager. The project manager is operable to manage data of a project wherein the data of the project includes libraries, document templates, and data sources. The rules engine is operable to build electronic business rules based on the libraries and the data sources. The user interface manager is operable manage the building of the electronic business rules using a graphical interface.

### CROSS-REFERENCE TO RELATED APPLICATIONS

This application claims the benefit of U.S. Provisional Application No. 60/858,903, filed on Nov. 14, 2006. The disclosures of the above application is incorporated herein by reference.

### FIELD

The present disclosure relates to generally to software development tools. More specifically, the present disclosure relates to a user-driven graphical software development tool for creating business rules and generating and maintaining intelligent outputs.

### BACKGROUND

The statements in this section merely provide background information related to the present disclosure and may not constitute prior art.

Business applications generally require some sort of “intelligent” input to make the application useful. Typically, this intelligence is provided by logic that is defined by a business person. A technical person then translates the logic into machine readable code which is built directly into the application. When the logic changes, the business stakeholder works with the technical person to either redevelop or update the application.

Due to this process, typical business applications can be divided into two distinct parts either directly or abstractly. The first part includes a data collection application that collects the data. The second part includes a static reporting system which outputs the data in a form that the business user can use or share with others. This two-part process is time consuming, error prone in the sense that changes to the applications may break other uses, and requires the coordination of many different groups in order to be successful. Likewise, the output that is generally delivered from these applications is static and has to be regenerated in order to react to changes in the data and/or logic.

### SUMMARY

Accordingly, an intelligent document development system is provided. The intelligent document development system includes a computer readable medium. The computer readable medium bears a project manager, a rules engine, and a user interface manager. The project manager is operable to manage data of a project wherein the data of the project includes libraries, document templates, and data sources. The rules engine is operable to build electronic business rules based on the libraries and the data sources. The user interface manager is operable manage the building of the electronic business rules using a graphical interface.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a functional block diagram illustrating an intelligent document design system according to various aspects of the present disclosure.

FIG. 2 is a block diagram illustrating the relationship between electronic business rules and intelligent documents that are produced by the intelligent document design system according to various aspects of the present disclosure.

FIG. 3 is a functional block diagram illustrating a design application of the intelligent document design system of FIG. 1 according to various aspects of the present disclosure.

FIG. 4 is a data diagram illustrating a project of the intelligent document design system of FIG. 1 according to various aspects of the present disclosure.

FIG. 5a-5i illustrate a design graphical interface of the intelligent document design system of FIG. 1 according to various aspects of the present disclosure.

FIG. 6 is a functional block diagram illustrating a document management application of the intelligent document design system of FIG. 1 according to various aspects of the present disclosure.

FIG. 7a-7f illustrate a document graphical interface of the intelligent document design system of FIG. 1 according to various aspects of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

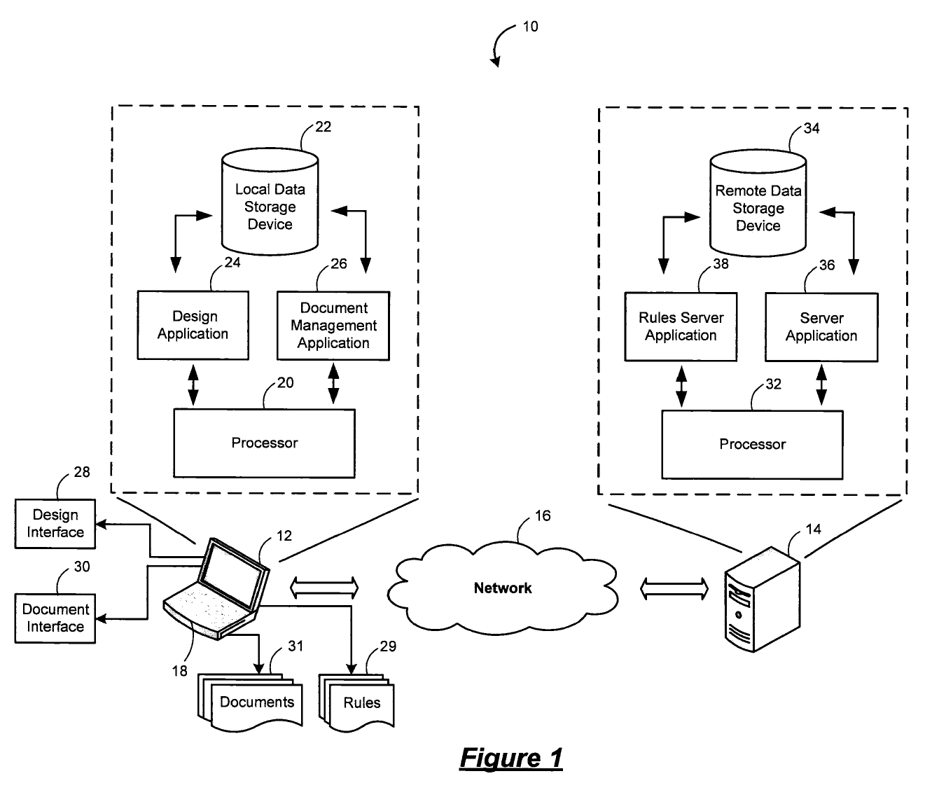

Referring now to FIG. 1, an exemplary intelligent document design system is shown generally at 10. The intelligent document design system 10 is shown to include a computer 12 that communicates data to and from one or more remote servers 14 via a network 16 based on a connectivity status of the computer 12 to the network 16. As can be appreciated, the computer 12 may be any computer system including, but not limited to, a laptop, a desktop, and a workstation.

The computer 12 can be associated with one or more input devices 18 that are used by a user to communicate with the computer 12. As can be appreciated, such devices 18 may include, but are not limited to, a mouse, a keyboard, and a touchpad. As will be discussed further below, the user communicates with the computer 12 to build, test, and integrate intelligent rules 29 and/or documents 31. In various embodiments, the user may build, test, and integrate intelligent rules 29 and/or intelligent documents 31 regardless of whether the computer 12 is connected to the network 16.

In various embodiments, the user can act as one of a data designer, a rule builder, a document architect, and/or a document user. As can be appreciated, the intelligent document design system 10 can include multiple computers (not shown) that communicate via the network 16, each computer used by a user acting as one of the data designer, the rule builder, the document architect, or the document user. For ease of the discussion, the disclosure will be discussed in the context of a single computer 12 being used by one or more users to build, test, and integrate the intelligent rules 29 and/or the intelligent documents 31.

As shown, the computer 12 includes a processor 20 and one or more local data storage devices 22. The one or more local data storage devices 22 can be at least one of random access memory (RAM), read only memory (ROM), a cache, a stack, or the like which may temporarily or permanently store electronic data of the computer 12.

The processor 20 of the computer 12 is operable to execute one or more sets of instructions contained in one or more software applications. According to the present disclosure, the processor 20 executes instructions contained in a design application 24 and a document management application 26. The design application 24 and/or the document management application 26 can be accessed via the network 16 from the remote server 14. In various other embodiments, the design application 24 and/or the document management application 26 can be installed to the computer's local data storage device 22 or run from a portable storage device such as a CD-ROM (not shown) or a USB key (not shown).

The design application 24 manages the display and associated functions of a design graphical interface 28. A user interacts with the design graphical interface 28 using the input devices 18 of the computer 12. The design graphical interface 28 is used by the data designer, the rule builder, and/or the document architect to design and test the business rules 29, and to integrate the business rules 29 into the intelligent documents 31. The business rules 29, for example, can be applied to any business where standardized documents are generally produced. As will be discussed further below, the business rules 29 can incorporate any type of data, be reused in other rules, be shared across projects, be embedded in documents, and/or be invoked by external applications.

The document management application 26 manages the display and associated functions of a document graphical interface 30. A user interacts with the document graphical interface 30 using the input devices 18 of the computer 12. The document graphical interface 30 generates a final intelligent document by manipulating the business rules 29 embedded in the intelligent document template.

Similarly, the one or more remote servers 14 include a processor 32 and one or more remote data storage devices 34 (e.g., remote from the computer 12, but local to the remote server 14). The one or more remote data storage devices 34 can be at least one of random access memory (RAM), read only memory (ROM), a cache, a stack, or the like which may temporarily or permanently store electronic data of the remoter server 14.

The processor 32 of the remote server 14 is operable to execute one or more sets of instructions contained in one or more software applications. According to the present disclosure, the processor 32 is operable to execute one or more sets of instructions contained in a server application 36 and a data management application 38. In various embodiments, separate servers are provided, one for each application 36, 38. For ease of the discussion, the disclosure will be discussed in the context of a single server 14 that includes both the server application 36 and the data management application 38.

The server application 36 manages the deployment and activity of the design application 24 and the document management application 26. In one example, the server application 36 manages the authentication of users accessing the design application 24 and/or the document management application 26. In one example, the server application 36 manages the security of the data transmitted between the computer 12 and the remote server 14 for example, by encryption and decryption methods.

The data management application 38 handles the synchronization of data between the local data storage device 22 of the computer 12 and the remote data storage device 34 of the remote server 14. In one example, the data management application 38 uploads the business rules 29 and/or the intelligent documents 31 stored on the local data storage device 22 to the remote data storage device 34, allowing for other computers 12 accessing the network 16 to view, use, and/or edit the business rules 29 and/or the intelligent documents 31. In another example, the data management application 38 compares the business rules 29 and/or the intelligent documents 31 stored on the local data storage device 22 with the business rules 29 and/or the intelligent documents 31 stored on the remote data storage device 34 and updates either the local data storage device 22 or the remote data storage device 34 with the latest business rules 29 and/or intelligent documents 31.

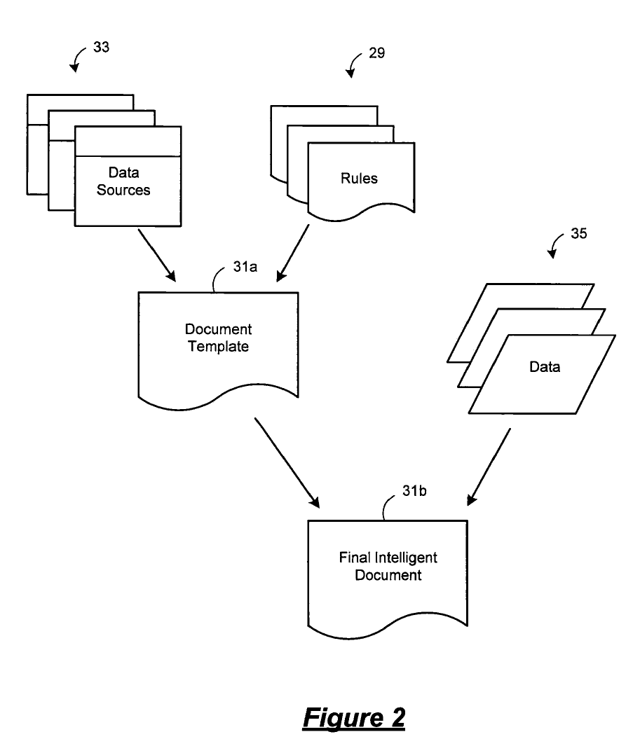

With reference to FIG. 2 and continued reference to FIG. 1, in one example, multiple users interact with the system to collectively generate business rules 29 and intelligent documents 31. For example, a data designer interacts with the design graphical interface 28 to create one or more datasources 33. The datasources 33 are used to gather and store data from various systems. A rule builder then interacts with the design graphical interface 28 to create or modify the business rules 29 using the datasources 33. A document architect interacts with the design graphical interface 28 to build intelligent document templates 31a by embedding the business rules 29 and datasources 33 into the document. A document user interacts with the document graphical interface 30 to generate a final document 31b by integrating actual data 35 into the datasources 33, manipulating the business rules 29 based on the actual data 35, and/or modifying text within the document.

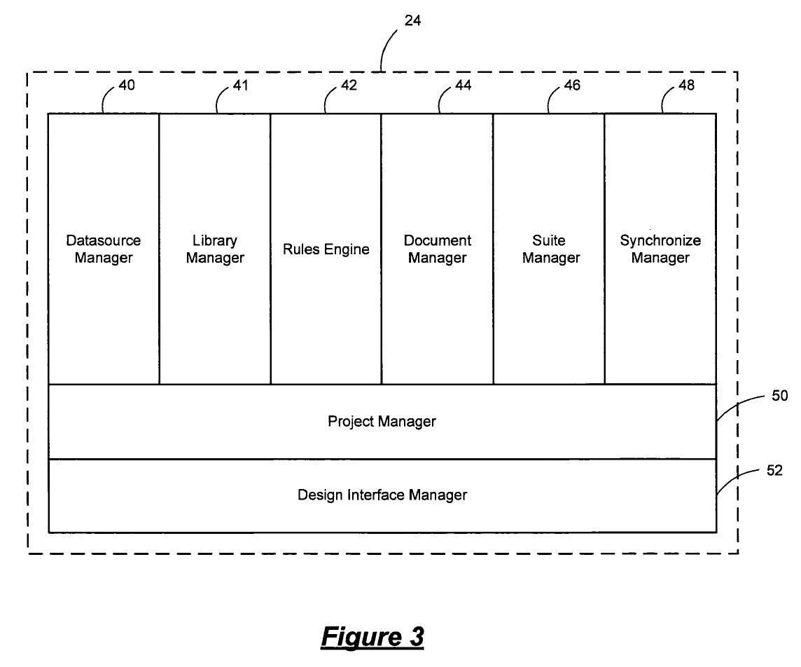

Referring now to FIG. 3, FIG. 3 illustrates a more detailed example of the design application 24. The design application 24 is shown to include one or more sub-applications. In one example, the sub-applications can include, but are not limited to, a datasource manager 40, a library manager 41, a rules engine 42, a document manager 44, a suite manager 46, a synchronize manager 48, a projects manager 50, and a design interface manager 52. As can be appreciated, the exemplary sub-applications can be combined and/or further partitioned to similarly design and test business rules 29 (FIG. 1) and integrate the business rules 29 (FIG. 1) into intelligent documents 31 (FIG. 1).

In various embodiments, the design application 24 manages the development of one or more projects. In one example, a project can be defined as an object according to object oriented programming (OOP) practices where the object includes one or more data elements (which may or may not be objects themselves) and one or more operations that can be performed on the data elements.

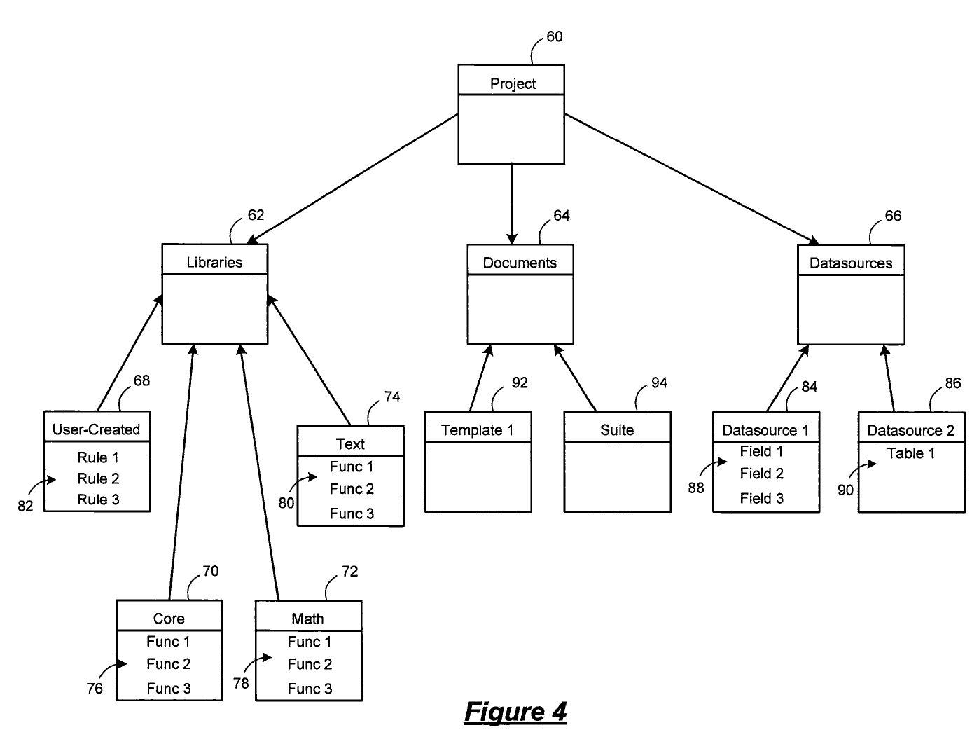

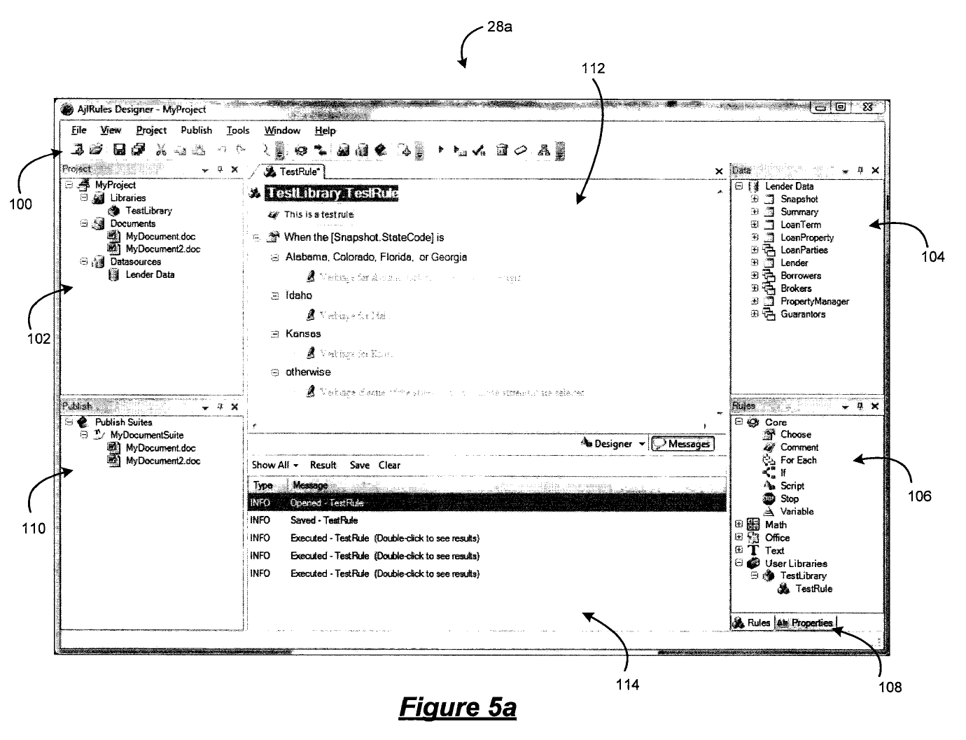

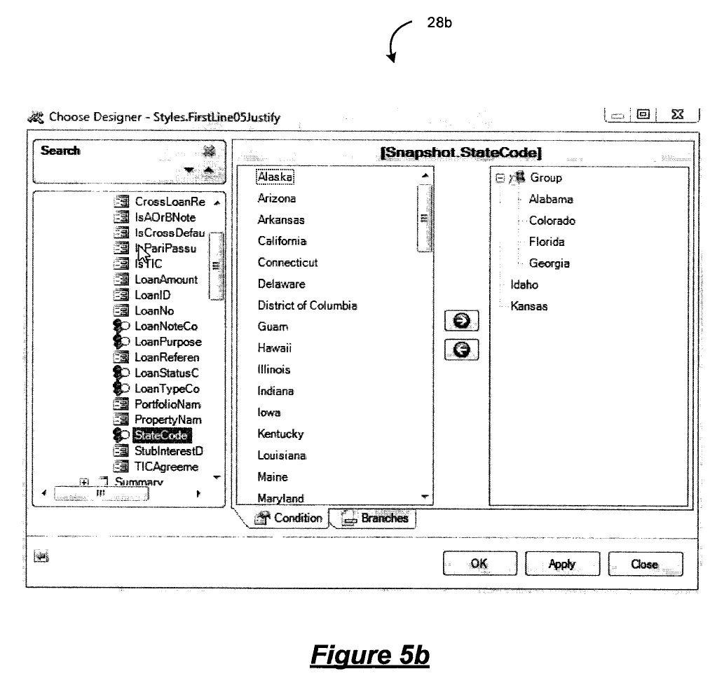

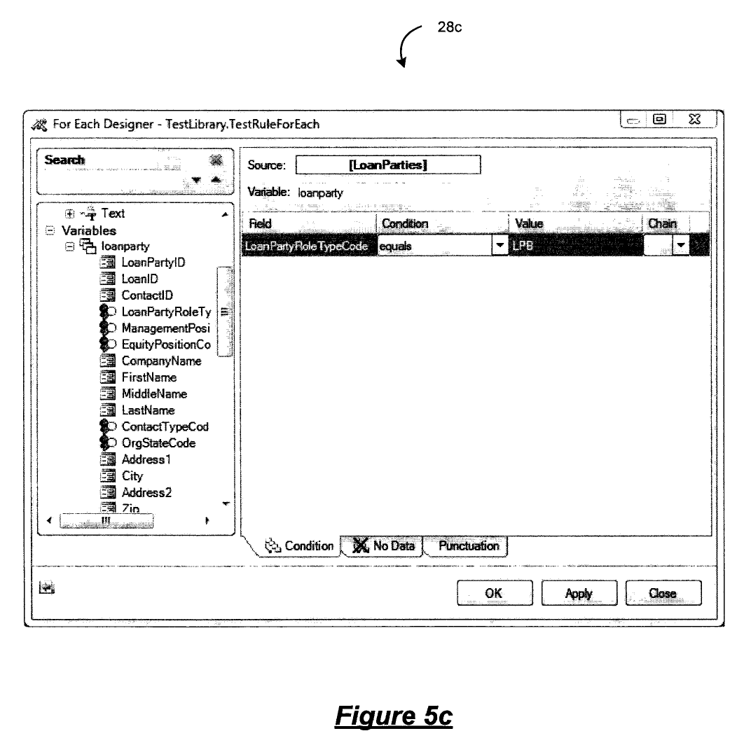

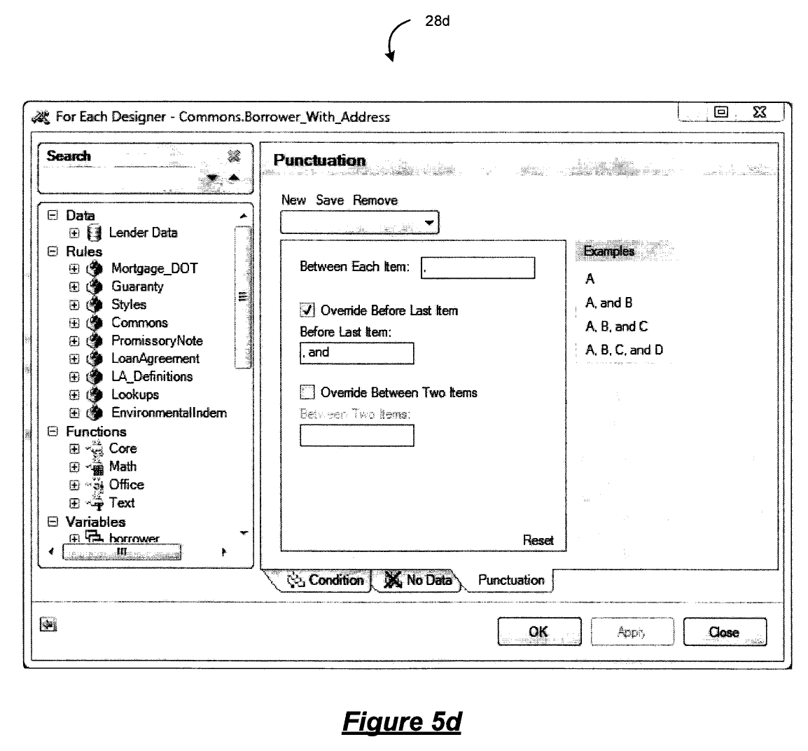

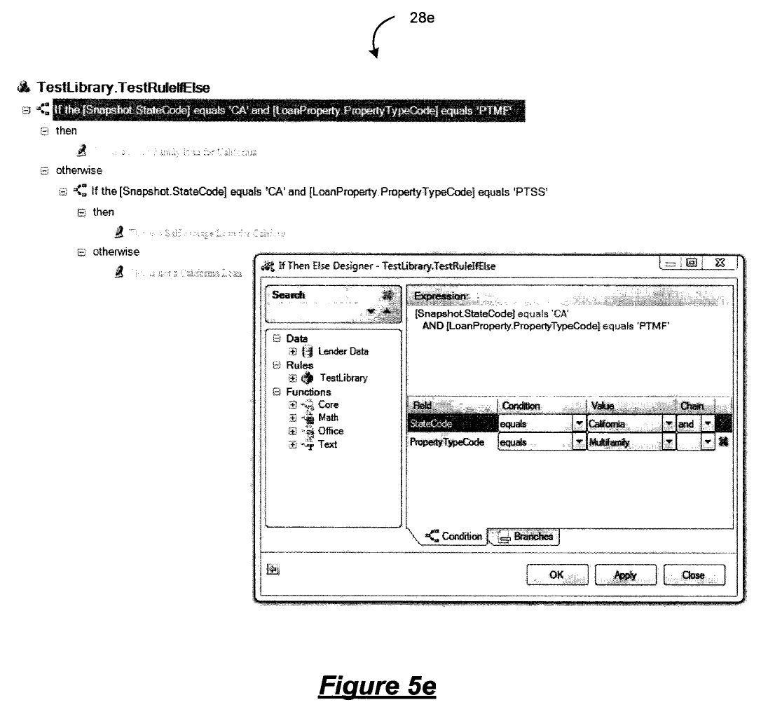

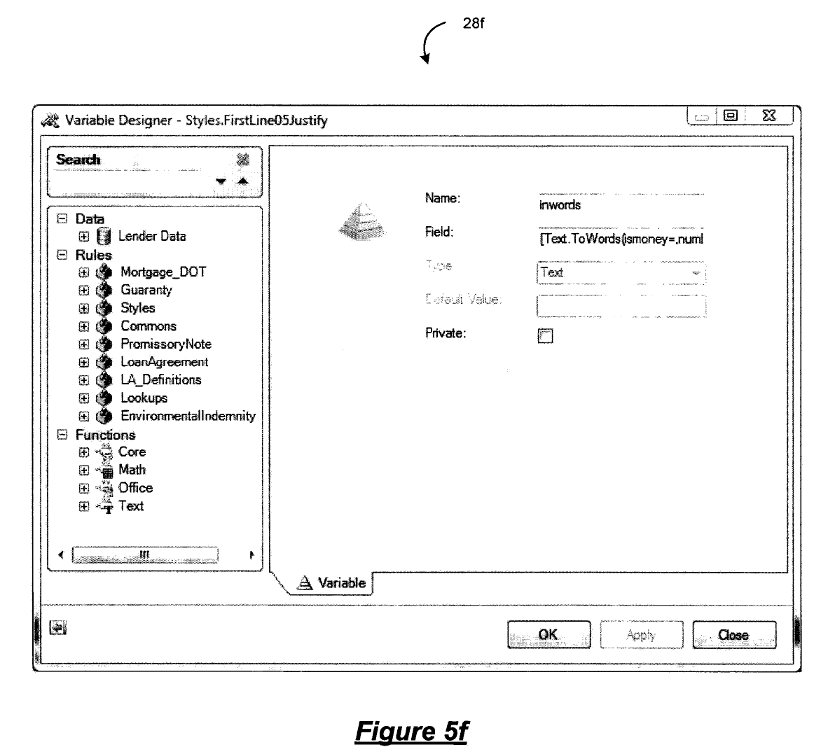

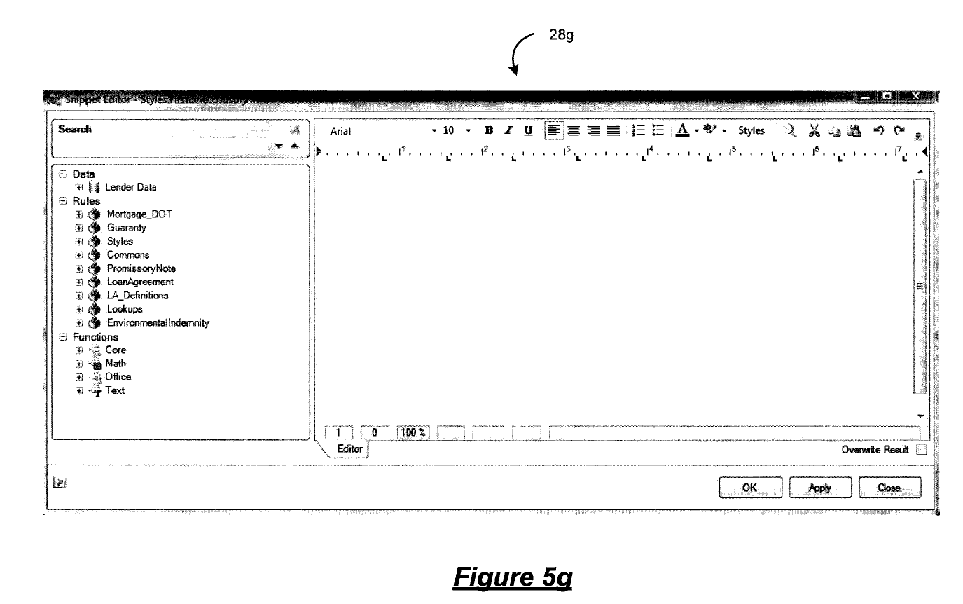

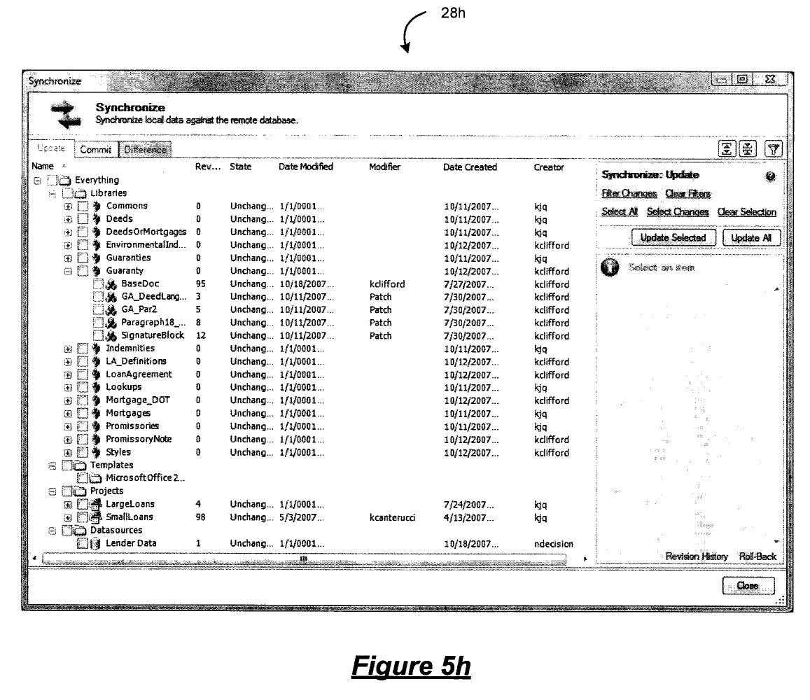

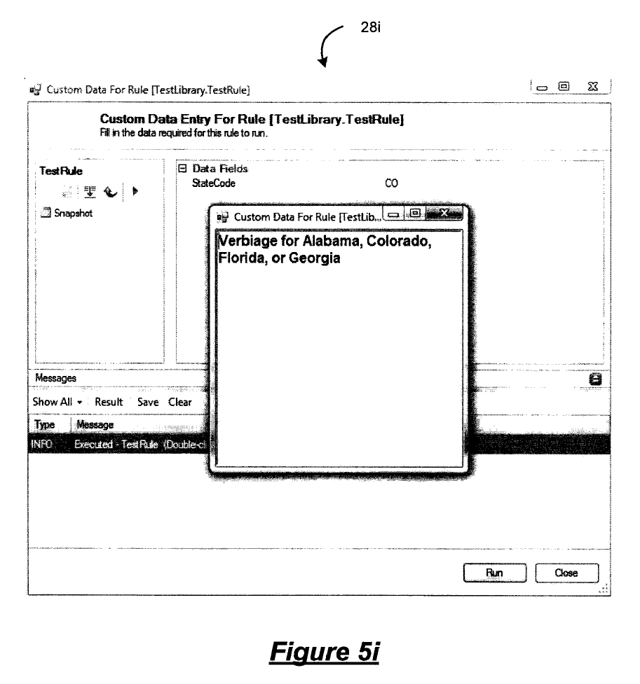

FIG. 4 illustrates an exemplary project 60. As shown in FIG. 4, a project 60 is composed of a collection of libraries 62, a collection of documents 64, and a collection of datasources 66. Each library 68-74 of the library collection 62 includes a collection of rules 82 and/or functions 76-80. The libraries 68-74 can be, for example, static libraries that define base functionality for rule building, static libraries defined by outside third parties, and/or dynamic libraries that include user-created rules. In various embodiments, the user-created rules 82 are built using base functions from the static libraries.

In one example, the static libraries can include, but are not limited to, a core library 70, a math library 72, and a text library 74. The core library 70 can include predefined base functions 76 for developing one or more rules 82. Such functions 76 can include, but are not limited to, a choose function (e.g., a select/case function, or a switch function), a comment function, a looping function, a conditional function, a script function, a stop function, and a variable function. The math library 72 includes predefined functions 78 for incorporating math routines into one or more rules 82. Such functions 78 can include, but are not limited to, an addition function, a subtraction function, a division function, and a multiplication function. The text library 74 includes predefined functions 80 for inserting and manipulating text within one or more rules 82. Such functions 80 can include, but are not limited to, an insert text function for creating bodies of text in which other rules and/or data can be embedded, a text formatting function, a text style function, and a text color function.

Each datasource 84, 86 of the collection of datasources 66 includes one or more data elements 88, 90 that define the data type to be manipulated by the functions 76-80 and/or the rules 82. The datasources 66 define the data structure indicating how the actual data is translated as will be discussed in more detail below. In one example, the data elements 88, 90 can include a data field (e.g., a single data element), a data table (e.g., a multiple data element), a lookup field (e.g., a data element for accessing the data table), or a view field (e.g., a data element for querying data elements).

Each document 90, 92 of the document collection 64 is an intelligent document template 92 that is formed using the rules 82 and the datasources 66. As will be discussed in more detail below, the document collection 64 can include a document suite 94 that is composed of a master document and one or more child documents, all of which are embedded into a single document. Changes to one document will be cascaded to the other documents.

With reference back to FIG. 3 and continued reference to FIG. 4, the project manager 50 manages the project 60 based on predefined operations. In one example, the project manager 50 creates a new project. In another example the project manager 50 removes a project from the local data storage device 22 (FIG. 1). In yet another example, the project manager 50 opens an existing project saved in the local data storage device 22 (FIG. 1). In yet another example, the project manager 50 saves a new project to the local data storage device 22 (FIG. 1).

The datasource manager 40 manages the datasources 66 of the project 60 based on predefined operations. In one example, the datasource manager 40 creates a new datasource by defining one or more fields or tables. In another example, the datasource manager 40 imports a datasource from other projects or applications. In yet another example, the datasource manager 40 removes a datasource from the project 60.

The library manager 41 manages the libraries 62 of the project 60 based on predefined operations. In one example the library manger 41 creates a new library to hold the user-created rules 82 for the project 60. In another example, the library manager 41 imports an existing library that includes one or more rules 82 or functions 76-80 into the project 60. In yet another example, the library manger 41 removes a library from the project 60.

The rules engine manages the development and testing of the rules 82 of the project 60 based on predefined operations. In one example, the rules engine 42 constructs new rules 82 by combining one or more functions 76-80 from the libraries 70-74, with the datasources 66, and/or with text entered by a user. In another example, the rules engine 42 can manage the nesting of rules 82 within rules 82 by allowing a new rule to be constructed from the rules 82 of the user-created libraries. In yet another example, the rules engine 42 can perform tests on the rules 82 by importing exemplary data into the datasources 66. The rules engine 42 then generates results of the testing for viewing by the user.

The document manager 44 manages the development of the document templates 92 of the project 60 based on predefined operations. In one example, the document manager 44 creates new documents for use in the project 60. In another example, the document manager 44 imports an existing document template into the project 60. In yet another example, the document manager removes a document from the project 60. In still another example, the document manager 44 modifies the document template 92 by at least one of adding text, embedding rules 82 and datasources 66, and formatting a document style.

The suite manager 46 manages the collection of multiple documents templates 92 into the document suite 94. In one example, the suite manager 46 creates a new document suite by designating a master document and associating one or more child document templates. In another example, the suite manager 46 opens a document suite and associates the document suite with the project 60. In another example, the suite manager 46 removes a document suite from the project 60. In yet another example, the suite manager 46 publishes the document suite 94 for use by the document management application 26 (FIG. 1). The document suite 94 can be published as a single master document with various child documents embedded within.

The synchronize manager 48 manages the synchronization of data stored in the computer 12 (FIG. 1) with data stored in the remote server 14 (FIG. 1). In one example, the synchronize manager 48 commits changes made by a user to the remote server 14 (FIG. 1). In another example, the synchronize manager 48 updates the local data storage device 22 (FIG. 1) of the computer 12 (FIG. 1) by getting the latest data that has been committed to the remote server 14 (FIG. 1). In various embodiments, the communication of the commitment and the updates can be performed by a data provider service when the computer 12 (FIG. 1) is connected to the network 16 (FIG. 1).

The design interface manager 52 controls the execution of the operations provided by the managers 40, 41, 44, 46, 48, and 50 and the engine 42 based on user input. The design interface manager 52 additionally manages the display of the design graphical interface 28 (FIG. 1) based on the user input.

For example, using the design graphical interface 28 (FIG. 1), a user can drag and drop the functions 76-80, rules 82, datasources 66 shown as objects on the design graphical interface 28 (FIG. 1) to build new rules. If the user is building a document template 92, the user can drag and drop the rules 82 onto a document template object. Once the document template 92 is built, the user can share the document template 92 with others by associating the document with a document suite 94 and publishing the document template 92 or the document suite 94.

An exemplary design graphical interface 28 is shown in FIGS. 4a-4i. With reference now to FIG. 4a, the exemplary design graphical interface 28a is shown to include a menu bar 100, a project tab 102, a data tab 104, a rule tab 106, a properties tab 108, a publish tab 110, a rule design space 112, and a message pane 114. A location of the tabs 102-110 is configurable. For example, the data tab 104 can be moved by selecting an area of the data tab 104 and dragging the data tab 104 across the rule design space 112 to the other side of the design graphical interface 28a.

The menu bar 100 can include drop-down menus, selectable icons, and/or a combination thereof for executing the above described operations. In one example, the menu bar 100 can include a new project icon, an open project icon, a save icon, a save all files icon, a cut icon, a copy icon, a paste icon, an undo icon, a redo icon, a search icon, an options icon, a synchronize icon, a manage libraries icon, a manage data sources icon, a manage published suites icon, a create new document icon, a run rule icon, a manually enter data into rule icon, a parse and validate rule icon, a clear rule icon, a remove node from rule icon, a flowchart toggle icon. The operation of each icon can be viewed by hovering a curser over the icon to display an informational window. Selection of one or more of the icons can initiate the display of a relevant window for executing the function associated with the icon.

The project tab 102 displays the current project and the defined elements. The elements of the project can be displayed in a tree format where the project is the base of the tree, and the libraries, documents, and data sources are listed as tree branches below the base. The project tab 102 includes hidden sub-menus or icons that allow a user to view libraries, open documents, and synchronize data in order to test the rules.

The rules tab 106 displays the libraries and their associated rules or functions. The libraries can be displayed in a tree format where the library is the base of the tree, and the rules and functions are listed as the tree branches below the base. The rules tab 106 includes hidden sub-menus or icons that allow a user to create new libraries and rules and to use existing library tools.

The data tab 104 displays the datasources. Each datasource can be displayed in a tree format where the datasource is the base of the tree and the tables and fields are listed as tree branches below the base. The data tab 104 can be used to insert the elements of the datasources into selected rules. The properties tab 108 displays details about a selected rule or library. The details can include, for example, a rule description, a current state, a created by field, a date modified, a version, and a modified by field.

The rule design space 112 displays a selected rule in a textual or graphical format. The rule design space 112 allows the user to design a rule by dragging and dropping functions from the static libraries displayed in the rules pane 106 to the rule design space 112. The dragging and dropping of the function initiates a function window for defining the rule using the function.

For example, as shown in FIG. 4b the choose function is selected to create a rule that will have several different outcomes based on a series of data fields. A choose window 28b is displayed upon selection of the choose function. As shown in FIG. 4c, a looping function is used when a rule processes a series of rows within a table. A looping window 28c or 28d is displayed upon selection of the looping function. As shown in FIG. 4e, a conditional function is used for rules that decide between two or more courses of action. If the first condition is met then the statement will be set to true and then a first option will run. If the first condition is not met, the statement will be set to false and will move to an otherwise branch. A conditional window 28e is displayed upon selection of the conditional function.

As shown in FIG. 4f, a variable function is used to create variables for temporarily storing or manipulating information that can be propagated to other rules. This value can be a data field or a text rule, or it can be typed into a “field” text box. A variable display window 28f is displayed upon selection of the variable function. As shown in FIG. 4g, a text function can be used to enter text into a rule. A text display window 28g is displayed upon selection of the text function.

As shown in FIG. 4h, upon selecting the synchronization icon, a synchronization window 28h is displayed. The synchronization window 28h allows the user to update the project with changes and commit changes of the project. The rules can be tested by entering example data into a data entry window 28i as shown in FIG. 4i.

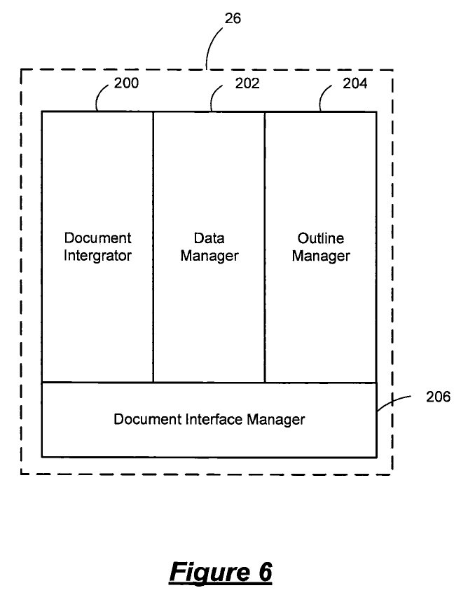

Referring now to FIGS. 2 and 6, FIG. 6 illustrates a more detailed example of the document management application 26. The document management application 26 is shown to include one or more sub-applications. In one example, the sub-applications can include a document integrator 200, a data manager 202, an outline generator 204, and a document interface manager 206. As can be appreciated, the exemplary sub-applications shown can be combined and/or further partitioned to similarly manage the integration of the intelligent document templates into final documents.

In various embodiments, the document integrator 200 manages the intelligent document templates 31a and the generation of the final documents 31b based on predefined operations. In one example, the document integrator 200 generates the final documents 31b based on the intelligent document templates 31a, the business rules 29, and the actual data 35. In particular, the document integrator 200 generates the final documents 31b by integrating the actual data 35 into the document templates 31a and applying the defined business rules 29 to the actual data 35. If the actual data 35 changes, the defined business rules 29 can be re-applied to generate an updated final document 31b. In another example, the document integrator 200 modifies the intelligent document templates 31a by embedding the business rules 29 and the datasources 33.

In various embodiments, the data manager 202 manages the actual data 35 based on predefined operations. In one example, the data manager 202 allows for the manual entering of the actual data 35 or for the automatic importing of the actual data 35 into the datasources 33 of the intelligent document template 31a. In another example, the data manager updates the actual data 35 from data stored in the local storage device 22 (FIG. 1). In yet another example, the data manager 202 modifies the actual data 35 stored in the local storage device 22 (FIG. 1).

The outline manager 204 manages a list of the business rules 29 and the datasouces 33 defined in the intelligent document template 31a. In one example, the outline manager 204 can highlight a location within the final document 31b that is associated with a selected electronic business rule 29 within the list of rules.

The document interface manager 206 controls the execution of the operations provided by the integrator 200, and the managers 202, 204 based on user input. The document interface manager 206 additionally manages the display of the document graphical interface 30 (FIG. 1) based on the user input.

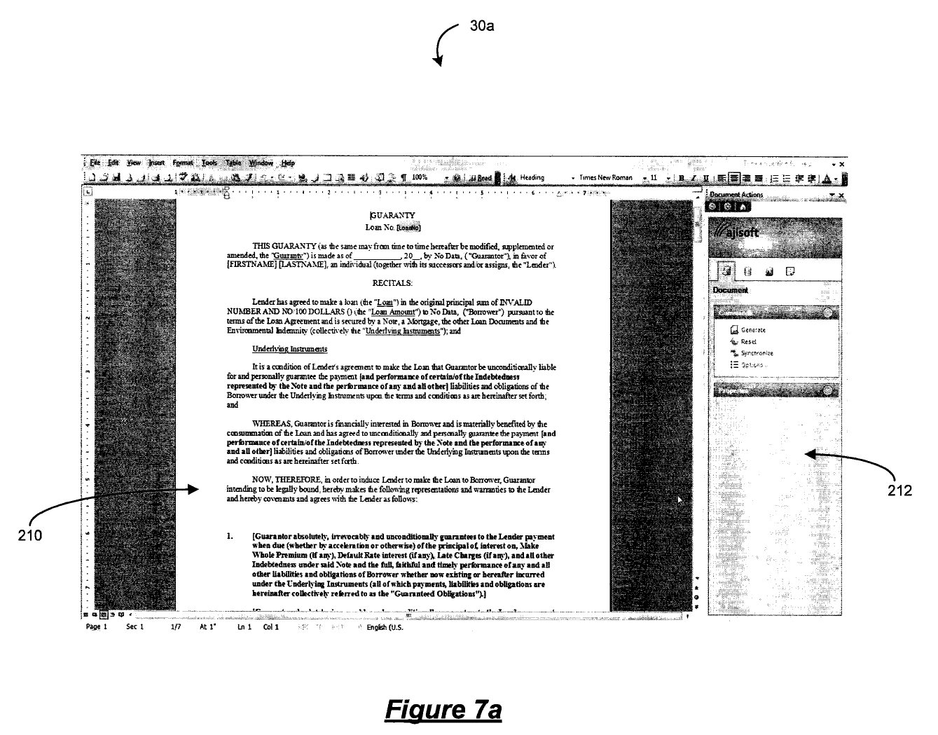

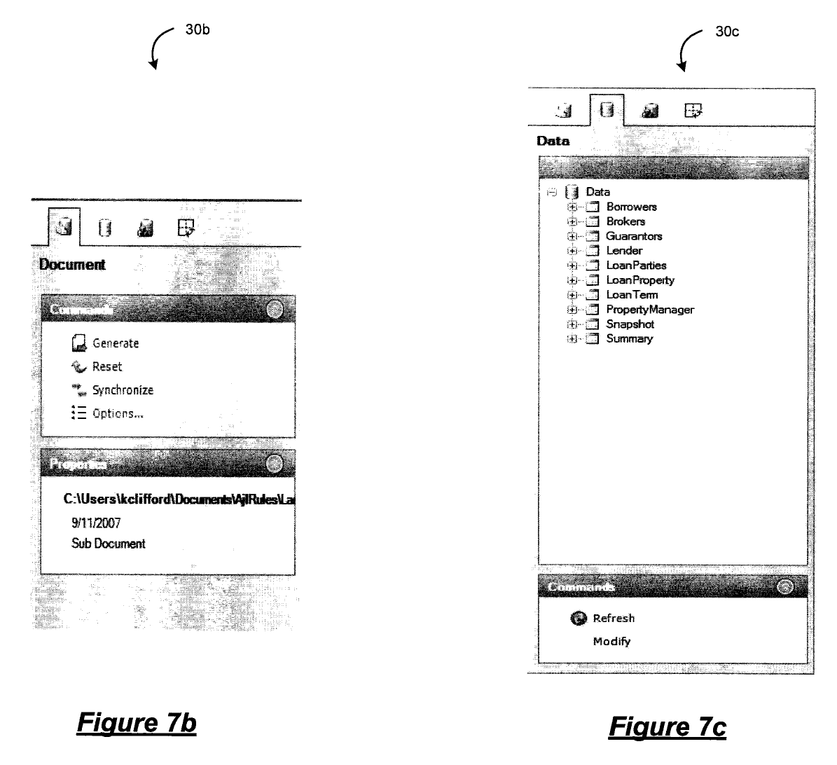

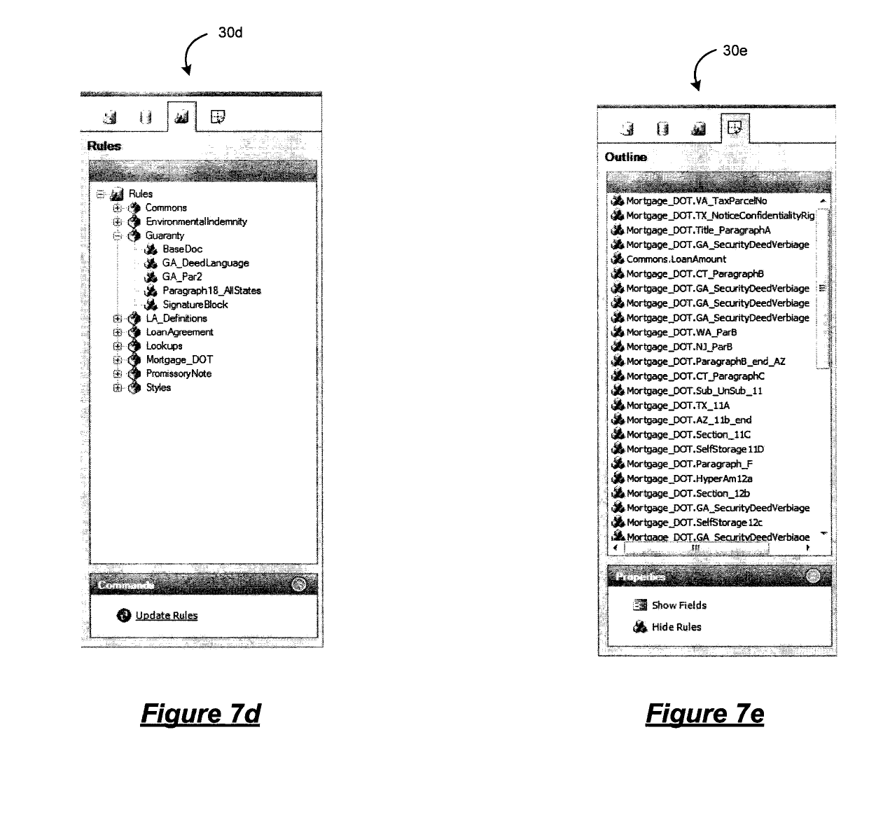

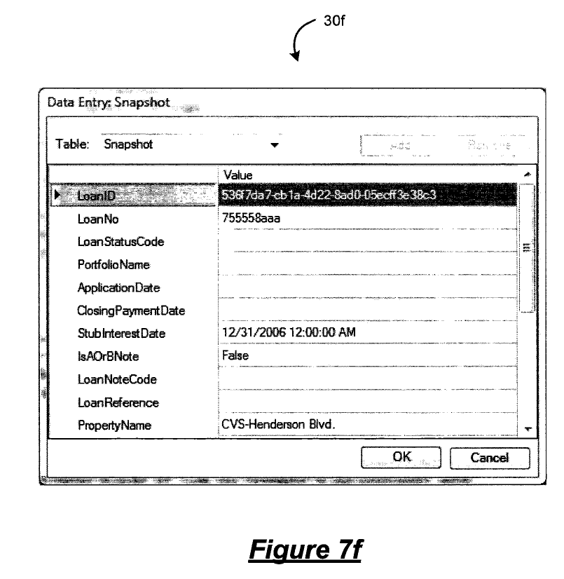

An exemplary document graphical interface 30 is shown in FIGS. 7a-7g. As shown in FIG. 7a, the exemplary document graphical interface 30 is shown to include a workspace 210 and a document manager 212. The document manager 212, as shown in FIGS. 7b-7e includes a document tab shown at 30b, a data tab 30c, a rules tab 30d, and an outline tab 30e. The tabs 30b-30e can be configured based on a user role and a level of security.

The document tab 30c is shown to include a commands pane and a properties pane. The commands pane lists the commands that can be performed on the document template or suite. Such commands can include, but are not limited to, generate final documents, reset documents, and synchronize documents with the data storage device. The properties pane lists properties associated with the document template or suite.

The data tab 30c is shown to include a data pane and a commands pane. The data pane displays the datasources and the actual data associated with the document template or the suite. The commands pane displays the commands that can be performed on the datasources. Such command can include, but are not limited to, refresh the data and modify the data. Upon selection of the modify command, a data entry window 30f is displayed as shown in FIG. 7f. The data entry window 30f dynamically displays the data and/or datasources for user editing.

The rules tab 30d displays all the rules that are available to embed into the intelligent document template. If a rule changes remotely while the intelligent document template is open, the rules can be updated by selecting the update rules command. The outline tab 30e is shown to include an outline pane and a commands pane. The outline pane lists the rules within the intelligent document template. The rules can be displayed in order from top down. A user can find a rule within the intelligent document template by selecting the rule from the outline. The rule can be highlighted in the workspace 210.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A document development system comprising:
a computer readable medium bearing,
a project manager operable to manage data of a project wherein the data of the project includes libraries, document templates, and data sources;
a rule engine operable to build electronic business rules based on the libraries and the data sources; and
a user interface manager operable manage the building of the electronic business rules using a graphical interface.

2. The system of claim 1 wherein the rule engine is operable to embed at least one of the electronic business rules and the data sources in the document templates.

3. The system of claim 1 wherein the graphical interface displays at least one of the project, the libraries, the document templates, and the data sources as objects, where the objects are selected, dragged, and dropped to build the electronic business rules.

4. The system of claim 1 wherein the libraries are at least one of static libraries that define base functionality to build rules, and dynamic libraries that include user-created electronic business rules.

5. The system of claim 4 wherein the rules engine is further operable to build the electronic business rules based on the user-created business rules.

6. The system of claim 1 further comprising a document manager operable to integrate the document templates into final documents based on the integration of the electronic business rules and the data sources with actual data.

7. The system of claim 6 wherein the document manager is further operable to modify the actual data and reintegrate the document templates into final documents based on the modified actual data.

8. The system of claim 1 further comprising a suite manager operable to designate a first document template of the document templates as a master template and to designate one or more second document templates of the document templates as child templates.

9. A method of developing intelligent documents comprising;
managing data of a project wherein the data of the project includes libraries, document templates, and data sources;
building electronic business rules based on the libraries and the data sources of the project; and
managing the building of the electronic business rules using a graphical interface.

10. The method of claim 9 further comprising embedding at least one of the electronic business rules and the data sources in the document templates.

11. The method of claim 9 further comprising displaying at least one of the project, the libraries, the document templates, and the data sources as objects in the graphical interface, where the objects are selected, dragged, and dropped to build the electronic business rules.

12. The method of claim 9 wherein the building comprises building the electronic business rules based on user-created business rules.

13. The method of claim 9 further comprising integrating the document templates into final documents by integrating the electronic business rules and the data sources with actual data.

14. The method of claim 9 further comprising modifying the actual data using the graphical interface and reintegrating the document templates into final documents based on the modified actual data.

15. The method of claim 9 further comprising designating a first document template of the document templates as a master template and designate one or more second document templates of the document templates as child templates.

16. The method of claim 15 further comprising publishing the master template and the child templates for use by other users.

17. A document development system comprising:
a first computer operable to build electronic business rules based on predefined libraries of functions and a collection of data sources using a drag-and-drop graphical user interface; and
a remote server operable to store the electronic business rules for use by one or more users.

18. The system of claim 17 wherein the first computer is operable to build the electronic business rules regardless of the connectivity to the remote server.

19. The system of claim 17 further comprising a second computer operable to integrate the electronic business rules stored in the remote server into document templates.

20. The system of claim 19 wherein the second computer is further operable to integrate the document templates into final documents based on the electronic business rules and actual data.
